(19) United States
(12) Patent Application Publication
(10) Pub. No.: US 2026/0200422 A1
(43) Pub. Date: Jul. 16, 2026

(54) FRONT-END MODULE FOR A VEHICLE

(71) Applicant: AUDI AG, lngolstadt (DE)

(72) Inventors: Sebastian ALBL, Weinböhla (DE); Annegret MALLACH, Hepberg (DE); Thomas SCHWARZ, Wettstetten (DE); Matthias WIEDMANN, Erding (DE)

(73) Assignee: AUDI AG, lngolstadt (DE)

(21) Appl. No.: 19/353,761

(22) Filed: Oct. 9, 2025

(30) Foreign Application Priority Data
Jan. 15, 2025 (DE) 102025101371.3

(51) Int. Cl. B60R 19/02; B60Q 1/04; B60R 19/24; B62D 25/08; B62D 65/16

(52) U.S. Cl. CPC B60R 19/023; B60Q 1/0433; B60R 19/24; B62D 25/084; B62D 65/16

(57) ABSTRACT

A front-end module for a vehicle includes a bumper cover having at least one recess for fastening the front-end module to a vehicle structure along a longitudinal direction (X-direction) of the vehicle, at least one fastening structure which is configured to fasten the front-end module to the vehicle structure in the longitudinal direction, and at least one cover which is attachable to the bumper cover from the outside in order to close the at least one recess after the fastening of the front-end module.

### FIELD

The technical area of the invention is front-end modules for vehicles.

### BACKGROUND

The prior art includes various solutions for attaching front-end modules to vehicle structures as well as measures for covering mounting openings.

DE 199 12 181 A1 describes a method for installing components of a front end of a motor vehicle, in which a bumper cover is screwed on.

DE 10 2008 051 290 A1 discloses a method for fastening a front-end module to a body shell of a vehicle.

### SUMMARY

The object of the invention is to provide a front-end module for a vehicle which enables and at the same time ensures simple fastening to the vehicle structure along the longitudinal direction.

The invention relates to a front-end module for a vehicle, which comprises a bumper cover having at least one recess. The recess is provided for fastening the front-end module to a vehicle structure along a longitudinal direction (X-direction) of the vehicle. In addition, the front-end module comprises at least one fastening structure configured to fasten the front-end module to the vehicle structure in the longitudinal direction. Furthermore, the front-end module comprises at least one cover attachable to the bumper cover from the outside in order to close the at least one recess after the front-end module has been fastened.

A front-end module is a pre-assembled assembly that comprises essential components of a front vehicle area and meets both functional and structural requirements. It serves as a central unit for the integration and assembly of various components that jointly form the front area of a vehicle. The front-end module is screwed on in the longitudinal direction (X-direction) of the vehicle, for example to impact absorbers of longitudinal members. The longitudinal direction (X-direction) of the vehicle refers to the axis that extends along the direction of travel, i.e. from the front side of the vehicle to the rear side. To enable mounting, the bumper cover has at least one recess, which is used, for example, as a clearance for a screw connection. This design avoids collisions of the screwing tools with the bumper cover, which would occur with a conventional design.

Mounting in the longitudinal direction (X-direction) offers multiple advantages. The direct screw connection enables quick and precise installation of the front-end module, since no additional work steps such as removing the bumper cover are required. The screw connection along the longitudinal axis increases the stability and load-bearing capacity of the module, since the forces are absorbed in the main load axis of the vehicle. The specially designed recesses in the bumper cover also allow for easy maintenance or removal of the front-end module without having to remove the entire bumper cover.

The front-end module can include multiple other components, including a crash management system positioned as a cross member between the longitudinal members and having the task of absorbing and distributing impact energy, a radiator package that includes the radiator, the fan, and other elements of the thermal management function for efficient engine cooling, a top chord that increases the stability of the module as load-bearing component and is used as a fastening point for other components, and headlights that contribute to the vehicle illumination and safety as integrated lighting units.

The bumper cover is an external covering that fulfills both aesthetic and aerodynamic functions. It protects the underlying structures and is used as a mounting point for other components. The recesses in the bumper cover enable precise and direct mounting of the front-end module on the vehicle structure. After installation, the recesses are closed using a cover or lighting element to prevent the penetration of water and dirt and to preserve the appearance of the bumper cover.

The cover can be designed in two variants: as a single, large-area component that completely covers one or more recesses, or as multiple smaller covers, each of which is individually attached to the recesses. In both cases, the cover can be integrated flush to optimize the aerodynamics of the vehicle and provided with a gasket to ensure reliable sealing. Alternatively, the cover or a lighting device integrated therein can perform additional functions such as ambient lighting or signal lights, which enhance the safety and functionality of the front-end module.

One advantage of the front-end module is that the bumper cover is provided with at least one recess which enables the module to be directly fastened to the vehicle structure along the longitudinal direction (X-direction). This allows the bumper cover to be part of the front-end module, and therefore the entire module, including the headlights, is pre-adjusted in terms of tolerance, thus saving assembly steps in production, but enabling x-assembly of the front-end module from the front in comparison to the prior art. At the same time, the externally attachable covers ensure that the recesses can be closed after mounting, preventing the penetration of water and dirt and maintaining the aesthetic integrity of the bumper cover.

Advantageously, the cover can be attached to the recess of the bumper cover in a form-fitting manner, so that a flush connection with the outer surface of the bumper cover results. This has the advantage that the outer surface of the cover blends seamlessly into the outer surface of the bumper cover, creating a uniform appearance.

Advantageously, the cover can be detachably fastened to the bumper cover by means of a clip mechanism, so that the cover can be removed to regain access to the fastening structure. The clip mechanism enables tool-free fastening and removal, which facilitates the maintenance of the front-end module.

Advantageously, the recess can be positioned and shaped to enable accessibility for a screw connection for fastening the front-end module to the vehicle structure. This ensures precise and efficient mounting of the front-end module.

Advantageously, the cover can include a seal which, in the installed state, presses against the edges of the recess of the bumper cover to prevent penetration of water and dirt into the recess. The seal contributes to the longevity of the screw connection and the vehicle structure.

Advantageously, the bumper cover can comprise multiple recesses at defined fastening points for the attachment of the front-end module, wherein for each recess a cover is designed such that it completely covers the respective recess after the mounting. The stability and load-bearing capacity of the front-end module is increased by the fastening to multiple fastening points.

Advantageously, the bumper cover can consist of a plastic material adapted to the aesthetic and functional requirements of the bumper cover. Plastic materials are light and durable, which reduces the overall weight of the vehicle.

Advantageously, the cover can comprise an integrated lighting device designed as an ambient light or signal light. This expands the functionality of the front-end module.

A further subject matter of the invention is a method for mounting the front-end module, comprising the following steps: positioning the front-end module on a vehicle structure along the longitudinal direction (X-direction) of the vehicle, fastening the front-end module to the vehicle structure by means of at least one screw connection which is accessible through at least one recess in the bumper cover, and closing the at least one recess after fastening the front-end module by means of a cover attachable from the outside.

One advantage of the method is that it enables efficient and precise mounting of the front-end module, wherein the positioning and fastening of the front-end module to the vehicle structure along the longitudinal direction (X-direction) of the vehicle simplifies the mounting.

Advantageously, the cover can be inserted into the recess in a form-fitting manner and fastened by means of a clip mechanism so that the cover can be removed without tools if necessary to make the screw connection accessible again. This makes it easier to remove the front-end module.

It is apparent that the above-mentioned features and the features still to be explained hereinafter can be applied not only in the particular specified combination but rather also in other combinations or alone, without leaving the scope of the present invention.

### BRIEF DESCRIPTION OF THE FIGURES

The invention is schematically illustrated in the drawings with the aid of embodiments. In the figures:

FIG. 1 shows a schematic representation of a front-end module according to the invention for a vehicle;

FIG. 2 shows the mounted front-end module from FIG. 1;

FIG. 3 shows a further embodiment of the front-end module according to the invention, in which the bumper cover includes two rectangular recesses;

FIG. 4 shows the front-end module from FIG. 3 after completion of the mounting.

The figures will be described coherently and comprehensively. Identical reference signs are assigned to the same components.

### DETAILED DESCRIPTION

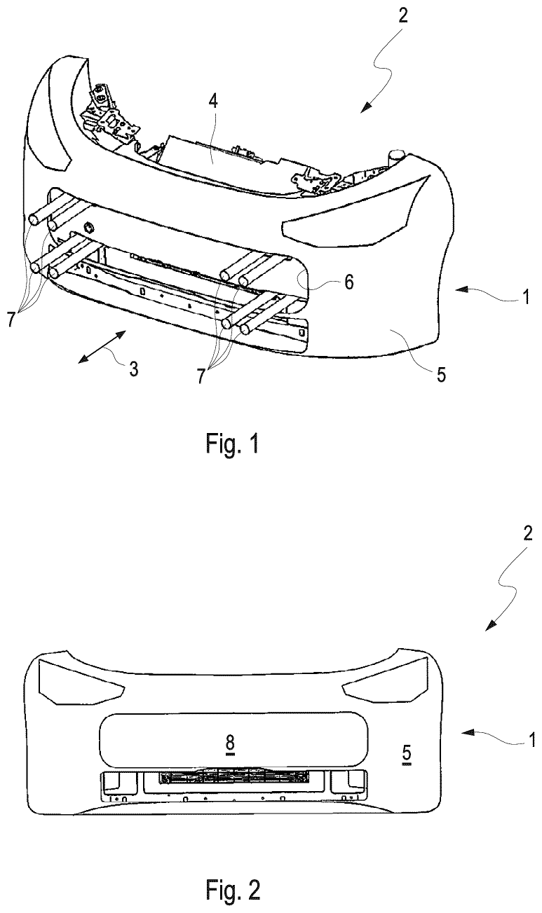

FIG. 1 shows a schematic representation of an embodiment of a front-end module 1 for a vehicle 2, which is mountable on a vehicle structure 4 in the longitudinal direction 3 (X-direction) of the vehicle 2. The front end module 1 comprises a bumper cover 5 which includes multiple recesses 6 to enable the fastening of the front end module 1. The recesses 6 in the bumper cover 5 are positioned to allow access to screw connections 7 which connect the front-end module 1 to the vehicle structure 4.

FIG. 2 shows the mounted front-end module 1 from FIG. 1, in which the recesses 6 are completely closed by a large-area cover 8. The cover 8 is attached to the bumper cover 5 and integrated flush into its outer surface to ensure a uniform appearance. The function of the cover 8 is to protect the underlying recesses 6 and screw connections 7 by preventing the penetration of water and dirt. The cover 8 also contributes to the aerodynamic optimization of the vehicle 2. In addition, FIG. 2 shows that the cover 8 occupies a central position in order to cover multiple recesses 6 simultaneously. The external design of the front-end module 1 displays a seamless design that fulfills both functional and aesthetic requirements.

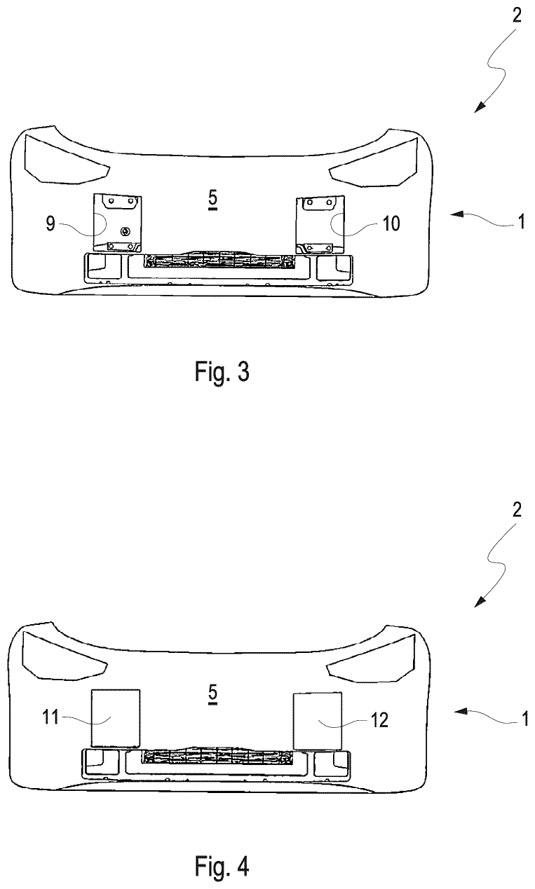

FIG. 3 shows a schematic representation of a further embodiment of a front-end module 1 for a vehicle 2, in which the bumper cover 5 includes two rectangular recesses 9, 10. Each of these recesses 9, 10 provides access to four recesses 6 underneath, which enable the front-end module 1 to be fastened to the vehicle structure 4 by means of the respective screw connections 7.

The rectangular recesses 9, 10 are arranged symmetrically on both sides of the bumper cover 5 and facilitate the mounting of the front end module 1 by providing direct access to the screw connections 7 underneath.

FIG. 4 shows the front-end module 1 from FIG. 3 after completion of the mounting, wherein the rectangular recesses 9, 10 are each closed using a cover 11 and 12, by which the underlying recesses 6 and screw connections 7 are protected from external influences such as water, dirt, or corrosion.

The rectangular design of the recesses 9, 10 enables precise alignment of the covers 8 and ensures that the mounting points can be integrated into the design of the bumper cover 5 in a functionally and visually seamless manner.

### LIST OF REFERENCE NUMERALS

1—front-end module
2—vehicle
3—longitudinal direction (X-direction)
4—vehicle structure
5—bumper cover
6—recess
7—screw connection
8—large-area cover
9—rectangular recess (left side)
10—rectangular recess (right side)
11—cover for left rectangular opening
12—cover for right rectangular opening

1. A front-end module for a vehicle, comprising: a bumper cover having at least one recess for fastening the front-end module to a vehicle structure along a longitudinal direction (X-direction) of the vehicle, at least one fastening structure which is configured to fasten the front-end module to the vehicle structure in the longitudinal direction, and at least one cover which is attachable to the bumper cover from the outside in order to close the at least one recess after the fastening of the front-end module.

2. The front-end module according to claim 1, wherein the cover is attached in a form-fitting manner to the recess of the bumper cover so that when the recess is closed using the cover, a flush connection with the outer surface of the bumper cover results.

3. The front-end module according to claim 1, wherein the cover is detachably fastened to the bumper cover by means of a clip mechanism, so that removal of the cover is possible to regain access to the fastening structure.

4. The front-end module according to claim 1, wherein the recess is positioned and shaped such that it allows accessibility for a screw connection for fastening the front-end module to the vehicle structure.

5. The front-end module according to claim 1, wherein the cover includes a seal which, in the mounted state, presses against the edges of the recess of the bumper cover when the recess is closed using the cover in order to prevent water and dirt from penetrating into the recess.

6. The front-end module according to claim 1, wherein the bumper cover comprises multiple recesses at defined fastening points for the attachment of the front-end module, wherein for each recess a cover is designed such that it completely covers the respective recess after mounting.

7. The front-end module according to claim 1, wherein the bumper cover consists of a plastic material and the cover is adapted to the aesthetic and functional requirements of the bumper cover.

8. The front-end module according to claim 1, wherein the cover comprises an integrated lighting device which is designed as an ambient light or as a signal light.

9. A method for mounting a front-end module according to claim 1, comprising the following steps: positioning the front-end module on a vehicle structure along the longitudinal direction (X-direction) of the vehicle, fastening the front-end module to the vehicle structure by means of at least one screw connection which is accessible through at least one recess in the bumper cover, and closing the at least one recess after fastening the front-end module by means of a cover attachable from the outside.

10. The method according to claim 9, wherein the cover is inserted into the recess in a form-fitting manner and is fastened by means of a clip mechanism, so that the cover can be removed without tools if necessary in order to make the screw connection accessible again.

11. The front-end module according to claim 2, wherein the cover is detachably fastened to the bumper cover by means of a clip mechanism, so that removal of the cover is possible to regain access to the fastening structure.

12. The front-end module according to claim 2, wherein the recess is positioned and shaped such that it allows accessibility for a screw connection for fastening the front-end module to the vehicle structure.

13. The front-end module according to claim 3, wherein the recess is positioned and shaped such that it allows accessibility for a screw connection for fastening the front-end module to the vehicle structure.

14. The front-end module according to claim 2, wherein the cover includes a seal which, in the mounted state, presses against the edges of the recess of the bumper cover when the recess is closed using the cover in order to prevent water and dirt from penetrating into the recess.

15. The front-end module according to claim 3, wherein the cover includes a seal which, in the mounted state, presses against the edges of the recess of the bumper cover when the recess is closed using the cover in order to prevent water and dirt from penetrating into the recess.

16. The front-end module according to claim 4, wherein the cover includes a seal which, in the mounted state, presses against the edges of the recess of the bumper cover when the recess is closed using the cover in order to prevent water and dirt from penetrating into the recess.

17. The front-end module according to claim 2, wherein the bumper cover comprises multiple recesses at defined fastening points for the attachment of the front-end module, wherein for each recess a cover is designed such that it completely covers the respective recess after mounting.

18. The front-end module according to claim 3, wherein the bumper cover comprises multiple recesses at defined fastening points for the attachment of the front-end module, wherein for each recess a cover is designed such that it completely covers the respective recess after mounting.

19. The front-end module according to claim 4, wherein the bumper cover comprises multiple recesses at defined fastening points for the attachment of the front-end module, wherein for each recess a cover is designed such that it completely covers the respective recess after mounting.

20. The front-end module according to claim 5, wherein the bumper cover comprises multiple recesses at defined fastening points for the attachment of the front-end module, wherein for each recess a cover is designed such that it completely covers the respective recess after mounting.
